(19) United States
(12) Patent Application Publication
(10) Pub. No.: US 2024/0385394 A1
(43) Pub. Date: Nov. 21, 2024

(54) ENHANCED MICRO-OPTICAL STRUCTURES FOR PARALLEL MICROLED LINKS

(71) Applicants: Rowan Pocock, Sunnyvale, CA (US); Sunghwan Min, Sunnyvale, CA (US); Howard Rourke, Sunnyvale, CA (US); Robert Kalman, Sunnyvale, CA (US)

(72) Inventors: Rowan Pocock, Sunnyvale, CA (US); Sunghwan Min, Sunnyvale, CA (US); Howard Rourke, Sunnyvale, CA (US); Robert Kalman, Sunnyvale, CA (US)

(21) Appl. No.: 18/667,940

(22) Filed: May 17, 2024

Related U.S. Application Data
(60) Provisional application No. 63/467,180, filed on May 17, 2023.

(51) Int. Cl. G02B 6/42

(52) U.S. Cl. CPC G02B 6/4206

(57) ABSTRACT

Structures to isolate optical coupling elements from contamination during certain steps in assembling a parallel microLED optical link are disclosed. The structures include a dam structure around a coupling optics block, for coupling light from and/or to microLEDs and/or photodetectors, respectively, that would sit flush to a ferrule or connector that holds an optical transmission medium. The ferrule may be, for example, a multi-fiber push on (MPO) connector or an MTP connector.

### CROSS-REFERENCE TO RELATED APPLICATIONS

This application claims the benefit of U.S. Provisional Patent Application No.

63/467,180, filed on May 17, 2023, the disclosure of which is incorporated by reference herein.

### BACKGROUND OF THE INVENTION

Computing and networking performance needs are seemingly ever-increasing. Prominent applications driving these needs include data center servers, high-performance computing clusters, artificial neural networks, and network switches.

For decades, dramatic integrated circuit (IC) performance and cost improvements were driven by shrinking transistor dimensions combined with increasing die sizes, summarized in the famous Moore's Law. Transistor counts in the billions have allowed consolidation onto a single system-on-a-chip (SoC) of functionality that was previously fragmented across multiple ICs. However, Moore's Law appears to be reaching its limits as shrinking feature sizes below 10 nm results in decreasing marginal performance benefits with decreased yields and increased per-transistor costs.

Beyond these limitations, a single IC can only contain so much functionality, and that functionality is constrained because the IC's process cannot be simultaneously optimized for different functionality, e.g. logic, DRAM, and I/O.

Increasingly, improving system performance is dependent on implementing very high bandwidth interconnects between multiple ICs. Inter-IC connections significantly limit performance of current systems. The power, density, latency, and distance limitations of these interconnects are far from what is desired.

Processor-memory interconnects are particularly important in computing systems. Dynamic random access memory (DRAM) is the most important form of memory due to its superior density and cost. However, DRAM is sensitive to temperature; the higher the temperature, the more frequently it needs to be refreshed. Because the memory is not accessible during refresh cycles, the increasing DRAM refresh rates at higher temperatures causes a loss of usable memory access bandwidth.

The trend in the highest performance DRAM such as High Bandwidth Memory (HBM) is to co-package the DRAM with high-performance processors in a multichip package. This causes the DRAM to be heated by the adjacent hot processor chip, resulting in a significant loss in DRAM IO performance. Thermally isolating the DRAM from processor chips can provide large improvements in IO bandwidth.

Optical interconnects can enable this thermal isolation and resulting memory IO bandwidth improvements. It is well-known that optical interconnects may provide fundamental advantages over electrical interconnects, even for relatively short interconnects of <<1 meter. To date, implementations of short optical interconnects have fallen short of what is needed in power, density, environmental robustness, reliability, and or cost.

### BRIEF SUMMARY OF THE INVENTION

Structures to isolate optical coupling elements from contamination during certain steps in assembling a parallel microLED optical link are disclosed. The structures include a dam structure around a coupling optics block that would sit flush to a ferrule or connector that holds an optical transmission medium. The ferrule may be, for example, a multi-fiber push on (MPO) connector or an MTP connector or, for example, a similar connector. Additional alignment keying features may be added to the coupling optics block and ferrule to enable accurate passive alignment of the transmission medium to the microLED/PD arrays. A second outer dam structure may be added to components outside of the coupling optics block, which could also aid in mechanically holding and aligning the optical transmission medium to the microLED/PD assembly. The combination of both the dam structure on the lenses and the outer dam structure may provide a two-fold barrier between the optical coupling elements and any external contaminants during subsequent assembly processes.

Some aspects of the invention provide a microLED and/or photodetector (PD) optical interconnect device including structure to isolate optical coupling elements from contamination, comprising: a plurality of microLEDs and/or PDs on a substrate; an optical fiber bundle positioned to be optically coupled to the microLEDs and/or PDs; a lens block including a plurality of lenses for coupling light between the plurality of microLEDs and/or PDs and fibers of the optical fiber bundle, the lens block including a dam circumferentially surrounding the plurality of lenses, the dam having a height greater than a height of the lenses; and a ferrule for the optical fiber bundle, the ferrule positioned to rest on the dam. Some aspects further comprise guide posts extending from the lens block, the guide posts extending in a same direction as the dam and past a height of the dam. In some aspects the ferrule includes a face with apertures or cavities for receiving the guide posts. In some aspects the guide posts are within a circumference defined by the dam. In some aspects the plurality of lenses are arranged on a regular grid. In some aspects the substrate is a semiconductor integrated circuit chip. In some aspects the lens block additional includes a lateral flange extending away from a circumference defined by the dam. In some aspects the lateral flange rests on the substrate. In some aspects the substrate comprises a silicon integrated circuit chip. Some aspects further comprise a further substrate, the silicon integrated circuit chip being on the further substrate. Some aspects further comprise an outer dam structure extending between the further substrate and the ferrule. In some aspects the outer dam structure is spaced apart from the silicon integrated circuit chip. In some aspects the outer dam structure circumferentially surrounds the silicon integrated circuit chip.

These and other aspects of the invention are more fully comprehended upon review of this disclosure.

### BRIEF DESCRIPTION OF THE FIGURES

FIG. 1 is a block diagram of a communication channel of a parallel optical interconnect.

FIG. 2 illustrates components of a parallel optical interconnect.

FIGS. 3A and 3B illustrate coupling of light into and out of a fiber core, respectively, in an optical interconnect.

FIGS. 4A and 4B further illustrate coupling of light into and out of a fiber core, respectively, in communication channel of a parallel optical interconnect.

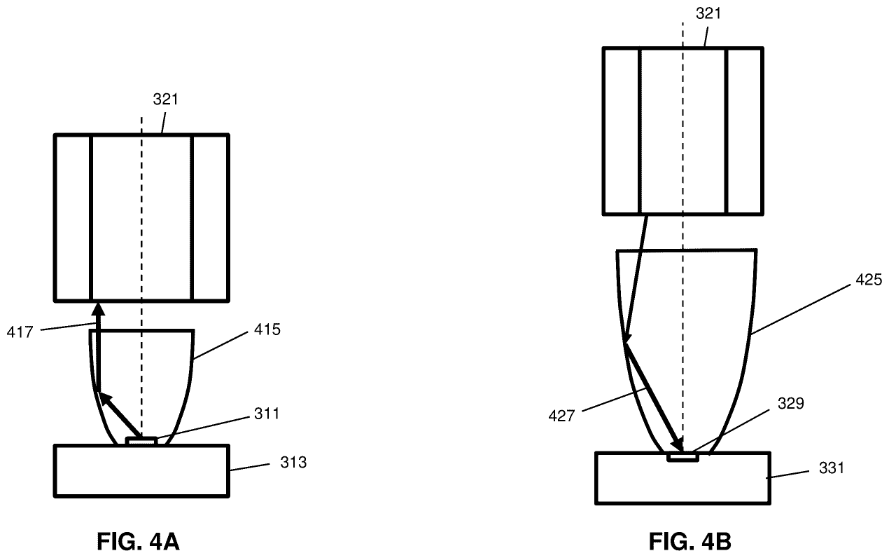

FIG. 5 illustrates a lens array for a parallel optical interconnect.

FIG. 6 is a side cross-sectional view of a transmitter and/or receiver of a parallel optical interconnect.

FIGS. 7A and 7B illustrate a lens array with exterior frame, for a parallel optical interconnect.

FIGS. 8A and 8B illustrate a lens array with exterior frame and guide posts, for a parallel optical interconnect.

FIG. 9 is a side cross-sectional view of a further transmitter and/or receiver of a parallel optical interconnect.

FIG. 10 is a side cross-sectional view of a transmitter or receiver, with lateral flange, of a parallel optical interconnect.

FIG. 11 is a side cross-sectional view illustrating an outer dam feature of a transmitter or receiver of an optical interconnect.

FIG. 12 is a side cross-sectional view illustrating inner and outer dam features of a transmitter or receiver of an optical interconnect.

### DETAILED DESCRIPTION

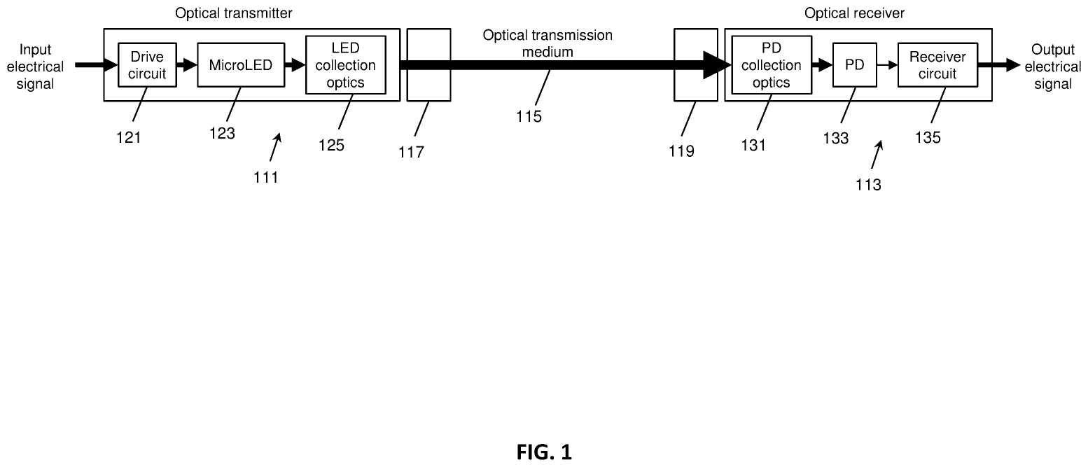

A parallel microLED optical interconnect comprises a plurality of optical communication channels. FIG. 1 is a block diagram of a communication channel of a parallel microLED optical interconnect. In some embodiments, each communication channel of a microLED optical interconnect comprises: an optical transmitter 111 comprising a microLED drive circuit 121 electrically connected to a microLED 123 that causes its input signal to be modulated onto the optical output of the microLED; microLED collection optics 125, input coupling optics 117 that couple light from the microLED into an optical transmission medium 115; the optical transmission medium; at the other end of the optical transmission medium, output coupling optics 119 that couple light to an optical receiver 113; the optical receiver comprising photodetector (PD) coupling optics 131, a PD 133, and a receiver circuit 135. In some embodiments, the optical transmission medium for each channel comprises an optical waveguide, for instance an optical fiber or a planar optical waveguide. In some embodiments the microLED collection optics and the input collecting outputs are combined into a single device, for example a lens. In some embodiments the microLED collection optics and the input collecting optics are omitted, for example with a fiber of the optical transmission medium butt-coupled to the microLED. Similarly, in some embodiments the PD collection optics and the output collecting outputs are combined into a single device, for example a lens. In some embodiments the PD collection optics and the input collecting optics are omitted, for example with a fiber of the optical transmission medium butt-coupled to the PD.

In some embodiments, a parallel microLED optical interconnect comprises a plurality of such communication channels. In some embodiments, microLEDs of the parallel microLED optical interconnect comprise an array of microLEDs located on some regular grid. In some embodiments, PDs of the parallel microLED optical interconnect comprise an array of PDs located on some regular grid. In some embodiments, microLEDs and PDs of the parallel microLED optical interconnect comprises an array of microLEDs and PDs located on some regular grid. In some embodiments, the microLED and/or PD grids may be hexagonal close-packed (HCP), square, or rectangular grids. In some embodiments, the center-to-center spacing of grid elements may be in the range of 20 um-100 um.

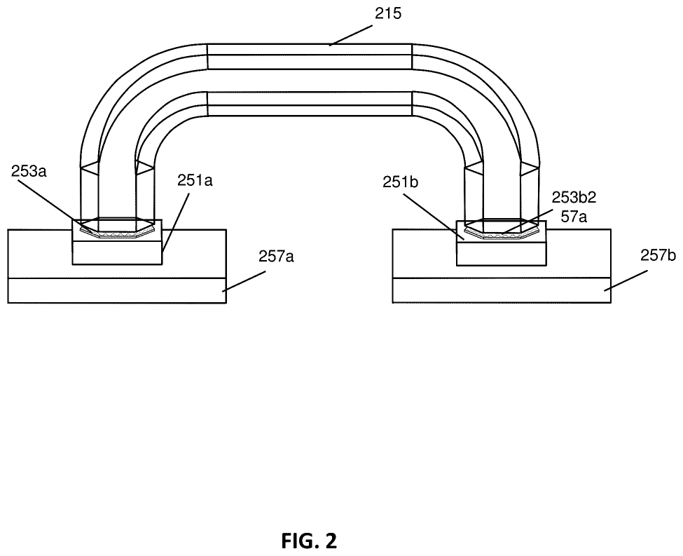

In some embodiments of a parallel microLED interconnect, the transmission medium comprises an array of optical fibers (a fiber “bundle”) or an array of optical waveguides. In some embodiments, the fiber bundle or waveguide array is part of an optical connector assembly that comprises a precision ferrule, for instance a Multi-fiber Push On (MPO) or Multi-fiber Termination Push-on (MTP) ferrule or ceramic ferrule. FIG. 2 illustrates components of a parallel optical interconnect including a fiber bundle. In FIG. 2, optical transceiver chips 253a,b are mounted on substrates 257a,b, respectively. The optical transceiver chips each include microLED drive circuits and receiver circuits. The substrates include electrical connections to the optical transceiver chips to provide communication paths to the optical transceiver chips, for example for data and/or clock signals. In many embodiments the communication paths begin or terminate at other chips (not shown in FIG. 2) which also may be mounted to the substrate. The electrical communication paths are coupled to microLED driver circuits and receiver circuits in the optical transceiver chips.

MicroLEDs and PDs are bonded to tops of the optical transceiver chips. The microLEDs and PDs may therefore be considered to be part of the optical transceiver chips. The microLEDs are electrically coupled to the microLED driver circuits and the PDs are electrically coupled to the receiver circuitry.

An optical fiber bundle 215 optically couples light between the optical transceiver chips.

In some embodiments, for each optical communication channel, an optical fiber is butt-coupled to the microLED and/or to the PD. In some embodiments, coupling optics are interposed between the microLED and/or the PD and the transmission medium. The use of coupling optics can decrease optical coupling losses, which is desirable to reduce the microLED drive current required to enable enough light to illuminate the PD such that the receiver can recover the transmitted bit stream with a low error rate.

In some embodiments, the coupling optics for each microLED or PD comprise a micro-lens that refracts the light such that that angular spread of the light exiting the lens is directed towards the component the light is configured to be transmitted towards. In FIG. 2, lens arrays 253a,b, one for each optical transceiver chip, are interposed between the microLEDs and PDs of each chip and ends of the optical fiber bundle. The lens arrays couple light from the microLEDs to fibers of the optical fiber bundle and from the fibers to the PDs.

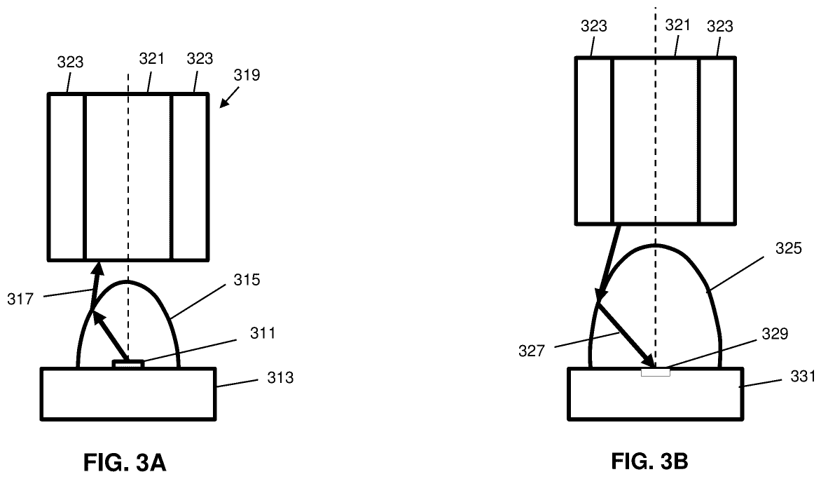

In some embodiments, the micro-lens may refract transmitted light from the microLED towards a fiber core such that the emitted light is collected into a smaller angular cone and substantially parallel to a normal axis of the microLED towards the fiber core of the optical waveguide. FIG. 3A illustrates light 317 from a microLED 311 refracted by a lens 315 into a fiber core 321. The microLED is on a substrate 313. The fiber core is longitudinally surrounded by cladding 323, with the fiber core and the cladding together comprising an optical fiber 319. In some embodiments, a micro-lens 325 may refract transmitted light 327 output from a fiber core 321 towards a PD 329, as illustrated in FIG. 3B. In FIG. 3B, the PD is shown as being formed in a substrate 331, instead of being bonded to the substrate. In some embodiments, the micro-lens may have an approximately spherical surface, or may have an aspheric surface. In some embodiments, the micro-lens may have a parabolic surface. In some embodiments, the micro-lens may encapsulate the microLED or PD. In some embodiments, the coupling optics for each microLED or PD comprise a reflector structure, for instance a quasi-parabolic reflector. In some embodiments, a reflector 415 may reflect emitted light 417 from the microLED 311 on the substrate 313 to an angle substantially parallel to the normal axis of the microLED and towards the fiber core 321. In some embodiments, a reflector 425 may reflect transmitted light 427 from the fiber core towards the PD.

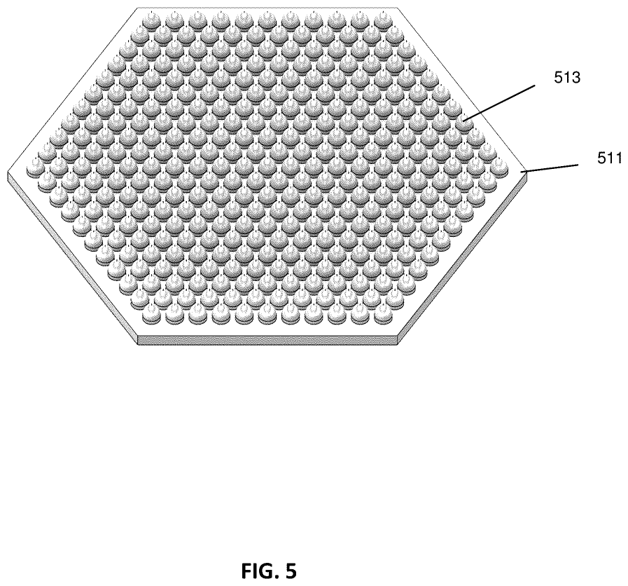

In some embodiments, the microLED and/or PD coupling optics for a parallel microLED interconnect comprise an array of optical elements, for instance an array of micro-lenses or an array of reflective couplers, where the grid spacing of the array of optical elements is matched to that of the associated microLED array or PD array. In some embodiments, this array of optical elements is part of a single contiguous block of some material, where the material may be a polymer or glass. FIG. 5 illustrates a lens array for a parallel optical interconnect. The lens array includes a plurality of lenses, for example lens 513. The lenses are on, and part of, a coupling optics block 511. The lenses are arranged on a regular grid, a hexagonal grid in the case of the embodiment of FIG. 5. In some embodiments, the coupling optics block is first fabricated and then bonded to the microLED or PD array. In some embodiments, the coupling optics block is formed by stamping a mold onto optical block material that is covering the microLED or PD array. In some embodiments, the coupling optics block or bonding material (e.g. epoxy, glass, or polymer) encapsulate the microLED or PD array such that there is no air gap between the coupling optics block and the microLED or PD array.

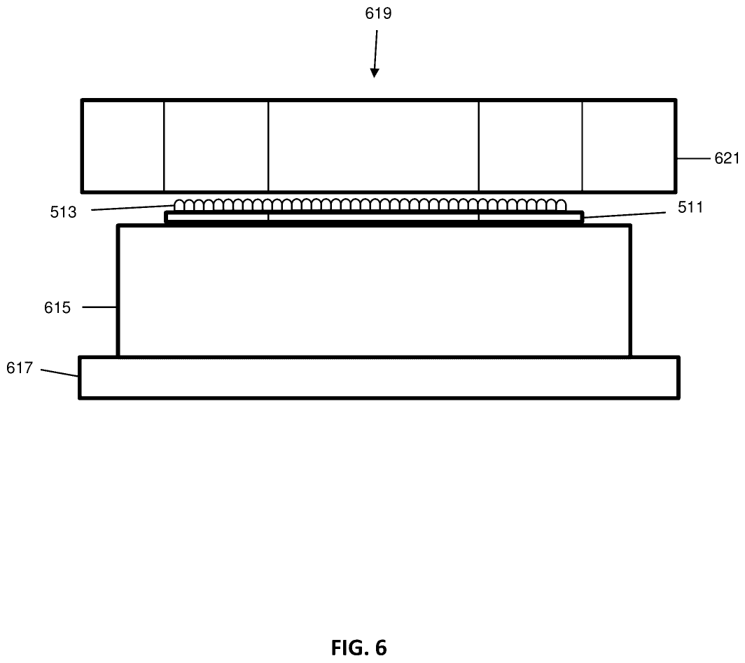

This process of attaching or molding the coupling optics block would typically be a single assembly step in a multi-step assembly flow. Other steps in such an assembly flow might include bonding an upper substrate to which the microLEDs and/or PDs are attached to an underlying substrate and attachment of an optical fiber bundle to the upper substrate. For reference, FIG. 6 is a side cross-sectional view of a transmitter or receiver of a parallel optical interconnect. In FIG. 6, microLEDs and/or PDs (not shown in FIG. 6) are attached to an upper substrate 615. The upper substrate may be, for example, an optical transceiver chip. The upper substrate 615 is bonded to an underlying substrate 617. The underlying substrate may be, for example, an interposer. A coupling optics block 511, including lenses 513, is on or above the microLEDs and/or PDs. An optical fiber bundle 619 is shown over the coupling optics block, with a hexagonal ferrule of a connector holding the optical fiber bundle visible in FIG. 6.

In assembly steps after attachment of the coupling optics, viscous fluids such as epoxy and underfill may be used to bond other components to the upper substrate. These subsequent assembly steps may contaminate the surface of the coupling optics, which may increase optical coupling losses, and increasing optical coupling losses is generally undesirable. Therefore, epoxy, underfill and general contamination preferably are carefully isolated from the coupling optics to avoid such contamination.

The potential assembly flow steps that use epoxy and underfill in close proximity to the coupling optics include but are not limited to the following processes: (1) Bonding the coupling optics to the microLED or PD arrays; (2) Bonding of the fiber bundle to a substrate; and (3) an underfill process on the substrate to set structures.

In Process (1), if the coupling optics block are bonded onto the microLED or PD array, the bonding material may wick around the coupling optics base and onto the coupling optics surface, causing contamination. For Process (2), the optical transmission medium or fiber bundle is generally required to be in close proximity to the coupling optics to minimize insertion loss. As such, the procedure for securing the fiber bundle in place may involve epoxy, and when in close proximity to the coupling optics may cause contamination. In Process (3), it is common practice in transceiver assembly to apply a layer of underfill to secure all components in place to create a rugged assembly. This blanket underfill may wick into the region between the coupling optics and optical transmission medium.

Contamination in Process (1) can be at least partially avoided by fabricating the elements of the coupling optics as a single block, for example as illustrated in FIG. 5, so that the epoxy will not wick between lenses.

To further avoid contamination of the air-lens medium for subsequent processes, an isolating structure may be built either onto the lens block and/or into other components. In some embodiments a ferrule of a connector holding the fiber bundle fits at edges or around edges of the block providing the coupling optics, for example as illustrated in FIG. 6. In some embodiments a dam structure may be provided around the coupling optics. In some such embodiments the ferrule of the connector holding the fiber bundle rests on top of the dam structure.

In some embodiments, the coupling optics block may comprise a continual “wall” structure, or dam, around a lens block. In some embodiments the dam extends vertically above the lenses by a designed separation distance between the lens structure and optical transmission medium. This structure acts as a gasket, and in some embodiments is provided by a gasket, to protect the optical surfaces of the coupling optics block from contamination, for example during Processes (2) and (3) as described above. A secondary function of this gasket structure would be to mechanically set the distance between the optical transmission medium and the coupling optics.

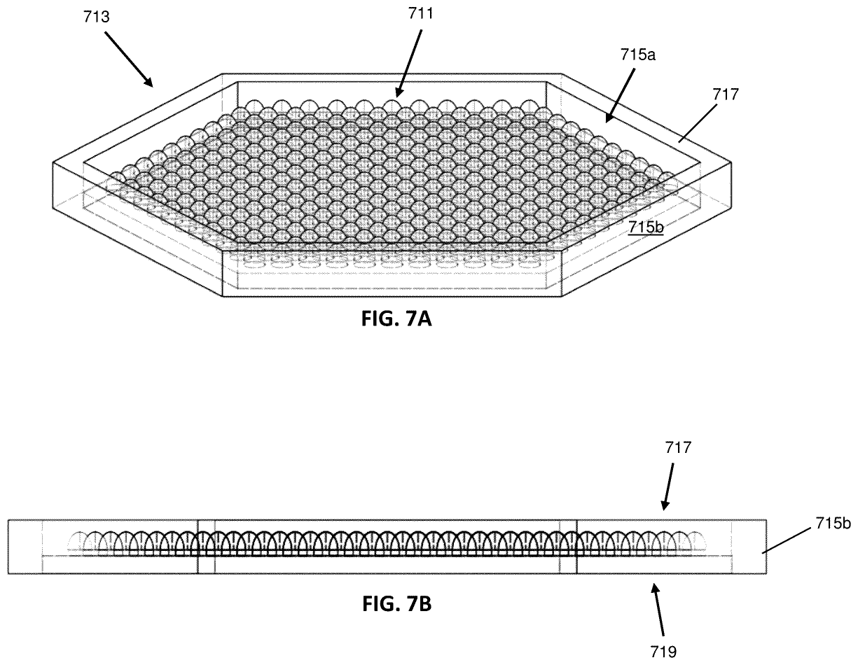

FIGS. 7A and 7B illustrate a coupling optics block with a circumferential dam, for a parallel optical interconnect. The coupling optics block includes a plurality of lenses 711. The lenses are arranged on a regular grid, for example to match a grid of an array of microLEDs and/or PDs. In FIGS. 7A and 7B, the lenses are arranged in the shape of a hexagon, but various embodiments may use square, rectangular, or other shapes.

The lenses are circumferentially surrounded by a dam 713. The dam includes an interior wall 715a. The interior wall extends from or about outer edges of a lens block 719 on which the lenses are located. In FIGS. 7A and 7B, the interior wall extends above a maximum height of the lenses. A corresponding exterior wall 715b of the dam is coupled to the interior wall by a top 717 of the dam. The exterior wall is shown as being parallel to the interior wall, with the top of the dam being perpendicular to both, but in various embodiments other configurations may be used.

In some embodiments, in addition to optical coupling elements and gasket structures, the coupling optics block may comprise other features that aid in assembly of the various parts. An example of such additional features are mechanical keying features that fit into mating structures on the ferrule of the fiber bundle to ensure accurate alignment.

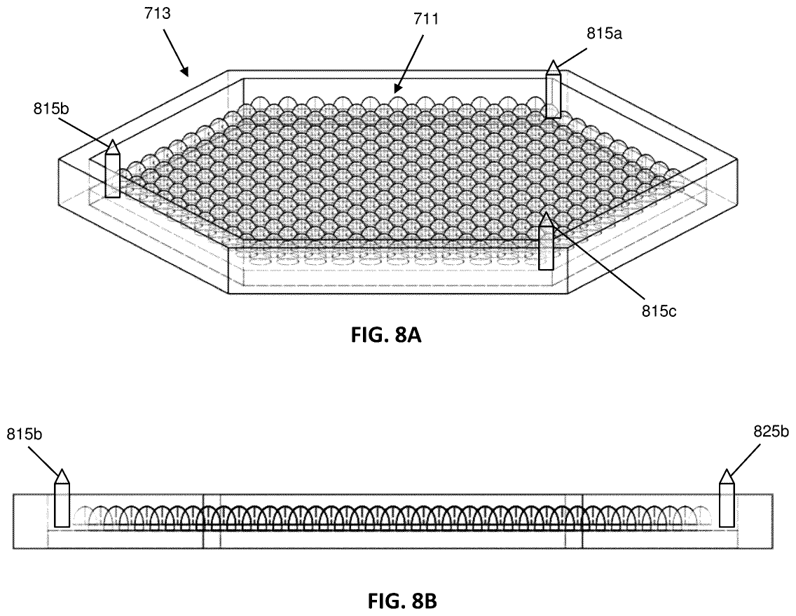

FIGS. 8A and 8B illustrate coupling optics blocks with an exterior frame and guide posts, for a parallel optical interconnect. The coupling optics block includes a plurality of lenses 711 circumferentially surrounded by a dam 713. The dam may be considered to form an exterior frame for a lens block having the lenses. The lenses and dam may be as discussed with respect to the embodiment of FIGS. 7A and 7B. The embodiments of FIGS. 8A and 8B additionally include guide posts 815a-c, 825b. The guide posts are shown as being interior to circumference of the dam, and extending upward from the lens block. As illustrated, the guide posts extend upward above the top of the dam. The guide posts may be received by corresponding cavities or apertures in, for example, a ferrule for an optical fiber bundle. The embodiment of FIG. 8A includes three guide posts, arranged at every other corner of the hexagonal lens block. The embodiment of FIG. 8B includes two guide posts, arranged at opposing corners of the hexagonal lens block.

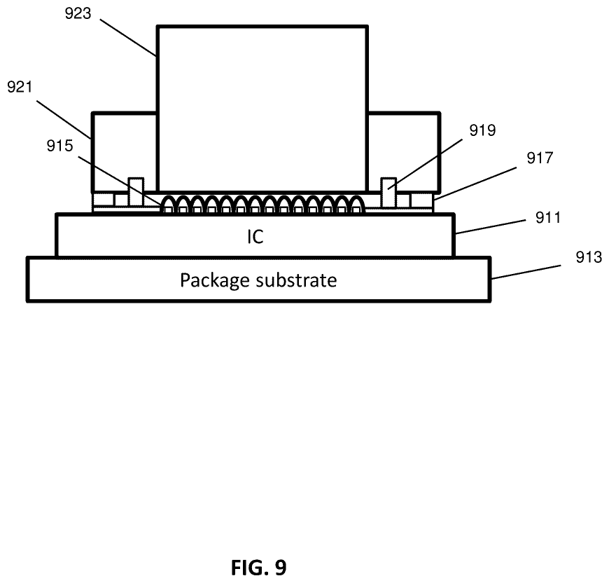

FIG. 9 is a side cross-sectional view of a further transmitter and/or receiver of a parallel optical interconnect. In FIG. 9, an integrated circuit chip 911 is on a substrate 913. The substrate may be, for example, a package substrate. In some embodiments the substrate may be an interposer. MicroLEDs and/or PDs are mounted to the chip, with a plurality of lenses 915 over the microLEDs and/or PDs. A dam 917 circumferentially surrounds the lenses. An optical fiber bundle is positioned to receive or provide light to or from the microLEDs and/or PDs, respectively, by way of the lenses. A ferrule 921 for the optical fiber bundle is shown as resting on the dam. More particularly, a bottom face of the ferrule may be considered as resting on a top of the dam. Guide posts 919 on a lens block for the lenses are fitted into cavities in the bottom face of the ferrule. The guide posts and apertures form a mechanical keying feature, to provide increased accuracy in positioning the fiber bundle with respect to the lens array.

Another example of such additional features to provide for increased accuracy of positioning of the fiber bundle are fiducial features that enable a machine vision-based positioning system to accurately position a fiber bundle/connector assembly to an array of microLEDs or PDs. Such features can enable accurate alignment and high optical coupling efficient from microLEDs/PDs to the optical transmission medium without the need for “active alignment”, where active alignment is defined as monitoring of optical coupling efficiency during the alignment process used for closed-loop alignment control.

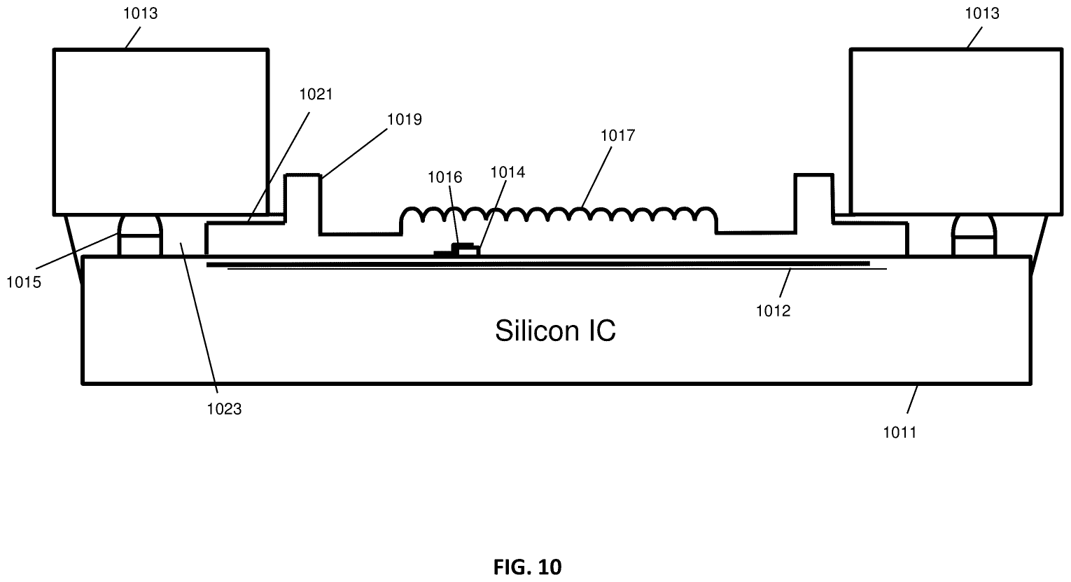

In some embodiments, the gasket around the outside of the lens block may have a lateral component in addition to a vertical component. FIG. 10 is a side cross-sectional view of a transmitter or receiver, with lateral flange, of a parallel optical interconnect. In FIG. 10, a silicon integrated circuit chip 1011 includes microLEDs and/or PDs, for example microLED 1014, on a top surface of the chip. Contacts, for example contact 1016, couple the microLEDs and/or PDs to an active layer 1012 in the chip. The active layer includes transistors, etc. for microLED driver circuits and/or receiver circuitry. The chip is connected to a PCB or package substrate by way of solder balls 1015.

The package substrate includes an aperture, for passage of, for example, an optical fiber bundle (not shown in FIG. 10) to receive light from the microLEDs or to provide light to the PDs. A plurality of lenses 1017 in a lens block are over the microLEDs and/or PDs. The lens block includes a dam 1017 at least partially within a volume defined by the aperture in the package. The dam is configured and positioned to abut a ferrule of the optical fiber bundle. The lens block also includes a lateral component 1021, or gasket, extending outward from the dam. In FIG. 10, the lateral component is shown as being on the surface of the silicon IC chip. Also in FIG. 10, the lateral component leaves space between itself and both the package substrate and the solder ball, allowing for underfill to enter those regions.

In some embodiments the vertical gasket component surrounds outer edges of the lens block and extends vertically above a base of the lens block, and in some embodiments above the lenses. In some embodiments the lateral gasket component surrounds outer edges of the vertical gasket, and in some embodiments extends radially outward from the vertical gasket. This lateral gasket component reduces the amount of underfill reaching the vertical gasket, reducing the potential for the underfill to reach the optical components and contaminate them. In some cases, the amount of underfill reaching the vertical gasket may be reduced sufficiently such that the underfill will not run over the top of the vertical gasket even if that gasket does not seal against the ferrule.

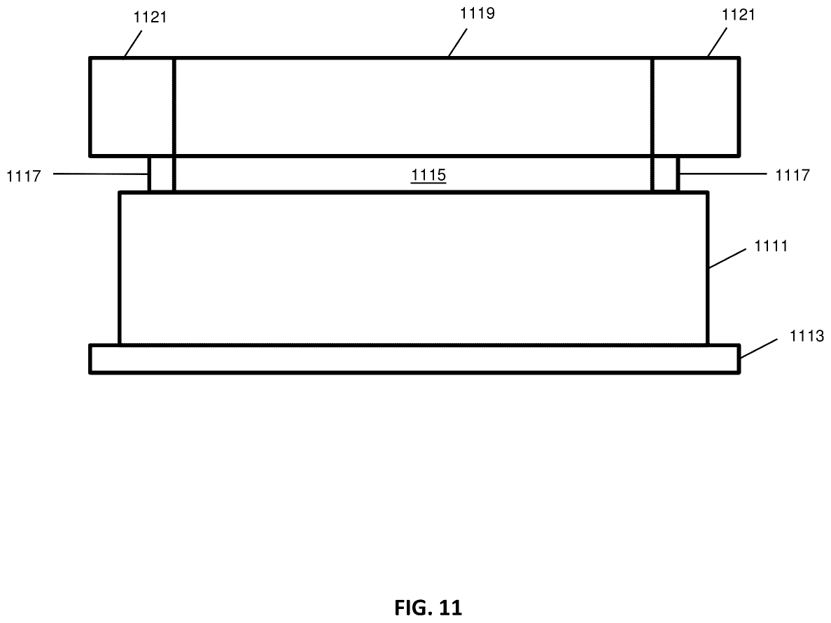

In some embodiments, the assembly includes a secondary outer dam structure outside of the coupling optics block, separated by an isolated outer region. For instance, an outer dam may be part of the optical connector assembly or ferrule that mechanically connects the optical transmission medium to one of the substrates. FIG. 11 is a side cross-sectional view illustrating an outer dam feature of a transmitter or receiver of an optical interconnect. In FIG. 11, a first substrate 1111 is on a second substrate 1113 The first substrate may be, for example, an integrated circuit chip with microLEDs and/or PDs bonded to a surface of the chip. Coupling optics 1115 are on the microLEDs and/or PDs, to couple light to optical fibers of a fiber bundle 1119. A ferrule 1121 for the fiber bundle rests on an outer dam structure 1117 on the surface of the chip. In some embodiments, complementary mechanical keying parts are on the optical connector side and substrate side, for instance pins that mate with holes. Within this structure, a dam on the substrate side could be added to prevent underfill from contaminating the optical coupling block surfaces.

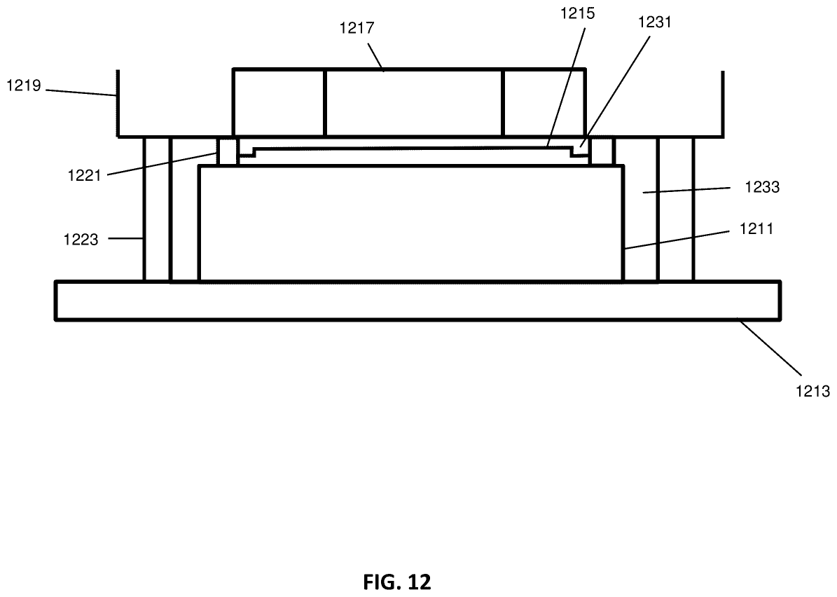

Combination of both the dam structure on the lenses and the outer dam structure provides a two-layer barrier between the lens-air medium and possible contamination. FIG. 12 is a side cross-sectional view illustrating inner and outer dam features of a transmitter or receiver of an optical interconnect. In FIG. 12, a substrate 1211, for example a semiconductor integrated circuit chip is on another substrate 1213. MicroLEDs and/or PDs are on a surface of the semiconductor IC chip, away from the other substrate 1213. A lens block 1215 including a plurality of lenses is on the surface of the semiconductor IC chip. An inner dam structure 1221 circumferentially surrounds the lens block. A ferrule 1219 of an optical fiber bundle 1217 rests on the inner dam structure. The optical fiber bundle is positioned to receive or transmit light to the microLEDs and/or PDs, by way of the lenses. Contact between the ferrule and the inner dam structure provides an isolated lens-air region about the lenses.

A secondary dam structure 1223 extends from the other substrate up to the ferrule. The ferrule also rests on the secondary dam structure. A gap 1233 between the secondary lens structure and the semiconductor IC ship provides an isolated outer region. In some embodiments the secondary dam structure circumferentially surrounds the semiconductor IC chip.

Although the invention has been discussed with respect to various embodiments, it should be recognized that the invention comprises the novel and non-obvious claims supported by this disclosure.

What is claimed is:

1. A microLED and/or photodetector (PD) optical interconnect device including structure to isolate optical coupling elements from contamination, comprising:
a plurality of microLEDs and/or PDs on a substrate;
an optical fiber bundle positioned to be optically coupled to the microLEDs and/or PDs;
a lens block including a plurality of lenses for coupling light between the plurality of microLEDs and/or PDs and fibers of the optical fiber bundle, the lens block including a dam circumferentially surrounding the plurality of lenses, the dam having a height greater than a height of the lenses; and
a ferrule for the optical fiber bundle, the ferrule positioned to rest on the dam.

2. The microLED and/or PD optical interconnect device including structure to isolate optical coupling elements from contamination of claim 1, further comprising guide posts extending from the lens block, the guide posts extending in a same direction as the dam and past a height of the dam.

3. The microLED and/or PD optical interconnect device including structure to isolate optical coupling elements from contamination of claim 2, wherein the ferrule includes a face with apertures or cavities for receiving the guide posts.

4. The microLED and/or PD optical interconnect device including structure to isolate optical coupling elements from contamination of claim 3, wherein the guide posts are within a circumference defined by the dam.

5. The microLED and/or PD optical interconnect device including structure to isolate optical coupling elements from contamination of claim 1, wherein the plurality of lenses are arranged on a regular grid.

6. The microLED and/or PD optical interconnect device including structure to isolate optical coupling elements from contamination of claim 1, wherein the substrate is a semiconductor integrated circuit chip.

7. The microLED and/or PD optical interconnect device including structure to isolate optical coupling elements from contamination of claim 1, wherein the lens block additional includes a lateral flange extending away from a circumference defined by the dam.

8. The microLED and/or PD optical interconnect device including structure to isolate optical coupling elements from contamination of claim 1, wherein the lateral flange rests on the substrate.

9. The microLED and/or PD optical interconnect device including structure to isolate optical coupling elements from contamination of claim 1, wherein the substrate comprises a silicon integrated circuit chip, and further comprising a further substrate, the silicon integrated circuit chip being on the further substrate.

10. The microLED and/or PD optical interconnect device including structure to isolate optical coupling elements from contamination of claim 9, further comprising an outer dam structure extending between the further substrate and the ferrule.

11. The microLED and/or PD optical interconnect device including structure to isolate optical coupling elements from contamination of claim 10, wherein the outer dam structure is spaced apart from the silicon integrated circuit chip.

12. The microLED and/or PD optical interconnect device including structure to isolate optical coupling elements from contamination of claim 10, wherein the outer dam structure circumferentially surrounds the silicon integrated circuit chip.
